(19) United States
(12) Patent Application Publication
(10) Pub. No.: US 2005/0238094 A1
(43) Pub. Date: Oct. 27, 2005

(54) Method and an apparatus for measuring phase noise

(75) Inventors: Masaki Bessho, Kobe-shi (JP); Hiroaki Ugawa, Kobe-shi (JP)

Correspondence Address: Paul D. Greeley, Esq.;Ohlandt, Greeley, Ruggiero & Perle, L.L.P., 10th Floor, One Landmark Square, Stamford, CT, 06901-2682, US

(73) Assignee: Agilent Technologies, Inc.

(21) Appl. No.: 11/102,263

(22) Filed: Apr. 8, 2005

(30) Foreign Application Priority Data
Apr. 21, 2004 (JP) 2004-124968

(51) Int. Cl. H04B 3/46

(52) U.S. Cl. 375/226

(57) ABSTRACT

A method measuring the phase noise of signals under test by generating first phase signals representing the phase of signals under test using first local signals generated while referring to first reference signals, generating second phase signals representing the phase of signals under test using second local signals generated while referring to second reference signals having a frequency different from that of the first reference signals, and finding the cross correlation or cross spectrum between the first phase signals and second phase signals. The apparatus of the present invention measures the phase noise of signals under test using this method.

### FIELD OF THE INVENTION

The present invention pertains to an apparatus and a method for measuring the phase noise of signals and in particular, relates to a method and an apparatus for measuring phase noise which use cross correlation.

### DISCUSSION OF THE BACKGROUND ART

There are phase noise sources inside conventional apparatuses for measuring phase noise and there are limits to the phase noise measurement precision thereof. Conventional apparatuses for measuring phase noise are constructed from parts having low phase noise properties in order to alleviate the effects of this internal phase noise on the measurement results. Moreover, the phase noise generated inside the apparatus for measuring phase noise is pre-determined as an error component and the measurement results are corrected using this error component (for instance, refer to JP unexamined Patent Publication (Kokai) No. 2003-287,555 (page 2, FIGS. 4 and 5)).

However, there are several problems with the above-mentioned apparatus for measuring phase noise. First, the necessary phase noise properties cannot be realized with conventional apparatuses for measuring phase noise. The minimum measurable noise level required for phase noise measurement has decreased each year. For instance, today the required phase noise property is 135 dBc/Hz (at an offset of 10 KHz and with a carrier of 1 GHz). However, when an apparatus for measuring phase noise is constructed using parts with a low phase noise property, noise is still generated from these parts; therefore, there are limits to the improvement in the performance of the apparatus for measuring phase noise. Even if the measurement results are corrected using pre-determined phase noise components, it is not possible to completely eliminate the phase noise component generated inside the apparatus for measuring phase noise.

Moreover, when a conventional apparatus for measuring phase noise processes signals under test several times before phase noise is measured, the effect of the phase noise generated by this signal processing on the measurement results cannot be eliminated. For instance, when a down converter is added upstream of the apparatus for measuring phase noise in order to increase the measurement frequency range, the apparatus for measuring phase noise will measure the phase noise of the signals under test, as well as the phase noise from the down converter. The same is true when an amplifier is added upstream of the apparatus for measuring phase noise in order to improve sensitivity. The same can also be said when these additional apparatuses or circuits are disposed upstream of the part for detecting phase noise inside the apparatus for measuring phase noise. It is often difficult to pre-determine the phase noise generated by these additional apparatuses and circuits. Therefore, these additional apparatuses and circuits must be constructed from parts having low phase noise properties in order to alleviate the effect thereof on the measurement results.

The following are some of the conventional measures that have been used in order to alleviate phase noise. That is, expensive parts having low noise properties are used in order to reduce the noise from each part of an apparatus; a PLL is multiplied in order to intersperse the effect of the PLL on the noise and to reduce the noise; or multiple switching is provided in order to assemble the optimal apparatus construction in accordance with output frequency. These measures raise total production cost and run contrary to the desired reduction in product cost. Moreover, today there is a demand for such low phase noise properties that they cannot be attained even when the above-mentioned measures are implemented, and in such cases, even if production cost is raised, there is not a corresponding improvement in the required properties.

Therefore, an object of the present invention is to solve the abovementioned problems and provide a method and apparatus for measuring lower level phase noise than was possible in the past. Another object of the present invention is to provide a method and an apparatus capable of measuring phase noise of a lower level than in the past from signals over a relatively broad frequency range.

### SUMMARY OF THE INVENTION

A method for measuring the phase noise of signals under test, characterized in that it comprises a step for generating first phase signals representing the phase of the signals under test; a step for generating second phase signals representing the phase of the signals under test; a step for finding the cross spectrum between the first phase signals and the second phase signals at least a pre-determined number of times; and a step for finding the average of this pre-determined number of cross spectra.

The present invention also pertains to a method for measuring the phase noise of signals under test characterized in that it comprises a step for generating first intermediate signals from the signals under test using a first signal processor; a step for generating second intermediate signals from the signals under test using a second signal processor separate from the first signal processor; a step for generating first phase signals representing the phase of the first intermediate signals; a step for generating second phase signals representing the phase of the second intermediate signals; a step for finding the cross spectrum between the first phase signals and the second phase signals at least a pre-determined number of times; and a step for finding the average of this pre-determined number of cross spectra.

Still yet, the present invention also pertains to a method for measuring the phase noise of signals under test characterized in that it comprises a step for generating first phase signals representing the phase of the signals under test using first local signals generated while referring to first reference signals; a step for generating second phase signals representing the phase of the signals under test using second local signals generated while referring to second reference signals having a frequency different from that of said first reference signals; and a step for finding the cross spectrum between the first phase signals and the second phase signals.

An apparatus for measuring the phase noise of signals under test by correlation processing or cross spectrum processing of at least two phase signals obtained from signals under test characterized in that it comprises a distributor for distributing the measured signals in at least two parts; a first phase detector, a second phase detector, a first terminal pair for opening the connection circuit between the distributor and the first phase detector, and a second terminal pair for opening the connection circuit between the distributor and the second phase detector; and in that the first and the second terminal pairs are either both shorted, or are both connected to separate outside signal processor.

An apparatus for measuring the phase noise of signals under test characterized in that it comprises a first phase detector for detecting the phase of first distributed signals distributed from the signals under test, a second phase detector separate from the first detector for detecting the phase of second distributed signals distributed from the signals under test, and a plurality of cross spectrum generator with different assigned frequency bands; and in that these cross spectrum generator find the cross spectrum between the output signals of the first phase detector and the output signals of the second phase detector at the assigned frequency band thereof, each of these cross spectrum generator repeatedly finds the cross spectrum between the output signals of the first phase detector and the output signals of the second phase detection means within the same time, and when two or more of these cross spectra are found within this time, vector averaging in terms of time is performed on the resulting two or more cross spectra.

A method for mapping to logarithmically spaced frequencies a spectrum that has been obtained from signals under test and that corresponds to linearly spaced frequencies in a measuring device comprising a step for selecting the spectrum that falls within a pre-determined frequency range of logarithmically spaced frequencies from the spectrum corresponding to linearly spaced frequencies and performing vector averaging on the selected spectrum.

A measuring apparatus characterized in that a spectrum corresponding to logarithmically spaced frequencies is generated by any of the methods set forth above.

By means of the present invention, phase noise is measured by correlating or cross spectrum processing; therefore, it is possible to measure phase noise of a lower level than in the past.

Moreover, by means of the present invention, averaging in terms of frequency is performed on a cross spectrum; therefore, phase noise of a lower level can be measured.

By means of the present invention, the above-mentioned correlating or cross spectrum processing is performed in a plurality of processing blocks; therefore, the number of times processing is performed per unit of time can be increased for each processing block and it is possible to measure phase noise of a lower level than when correlating or cross spectrum processing is performed a single time.

By means of the present invention, when phase noise is measured using correlating or cross spectrum processing, the frequency of the reference signal source is different from the other signal sources that participate in the measurements; therefore, it is possible to reduce the spurious effect of this signal source on the phase noise measured values.

By means of the present invention, when phase noise is measured using correlating or cross spectrum processing, the signals under test are distributed and each of the distributed signals under test is processed by a different signal processor; therefore, the effect of this signal processor on the phase noise measured value can be reduced. The effect of the present invention is obvious when, for instance, the signal processor is a frequency conversion means having a signal source.

### BRIEF DESCRIPTION OF THE DRAWINGS

FIG. 1 is a block diagram showing the structure of the first embodiment of the present invention, apparatus 100 for measuring phase noise.

FIG. 2 is a block diagram showing the structure of correlating device 150.

FIG. 3 is a drawing of the averaging results.

FIG. 4 is a block diagram showing the structure of the second embodiment of the present invention, apparatus 200 for measuring phase noise.

FIG. 5 is a block diagram showing the structure of the third embodiment of the present invention, apparatus 1000 for measuring phase noise.

FIG. 6 is a block diagram showing the structure of the fourth embodiment of the present invention, apparatus 2000 for measuring phase noise.

FIG. 7 is a block diagram showing the structure of the fifth embodiment of the present invention, apparatus 3000 for measuring phase noise.

FIG. 8 is a block diagram showing the structure of the sixth embodiment of the present invention, apparatus 4000 for measuring phase noise.

FIG. 9 is a block diagram showing the structure of the seventh embodiment of the present invention, apparatus 700 for measuring phase noise.

FIG. 10 is a block diagram showing the structure of the eighth embodiment of the present invention, apparatus 800 for measuring phase noise.

FIG. 11 is a block diagram showing phase noise measuring apparatus 900.

FIG. 12 is a drawing showing the averaging results.

### DETAILED DESCRIPTION OF THE PREFERRED EMBODIMENT

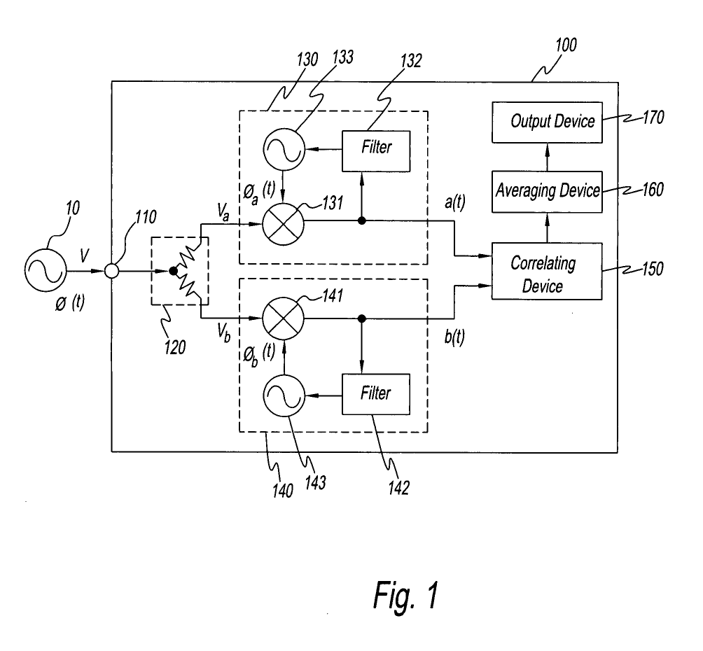

Preferred embodiments of the present invention will now be described while referring to the attached drawings as needed. The first embodiment of the present invention is an apparatus 100 for measuring phase noise. A block diagram showing the structure of apparatus 100 for measuring phase noise is shown in FIG. 1. A device under test 10 and apparatus 100 for measuring phase noise are shown in FIG. 1.

Device under test 10 outputs signals V under test, which are the object of phase noise measurement. Device under test 10 is a signal source or a part, apparatus, or system that applies signals.

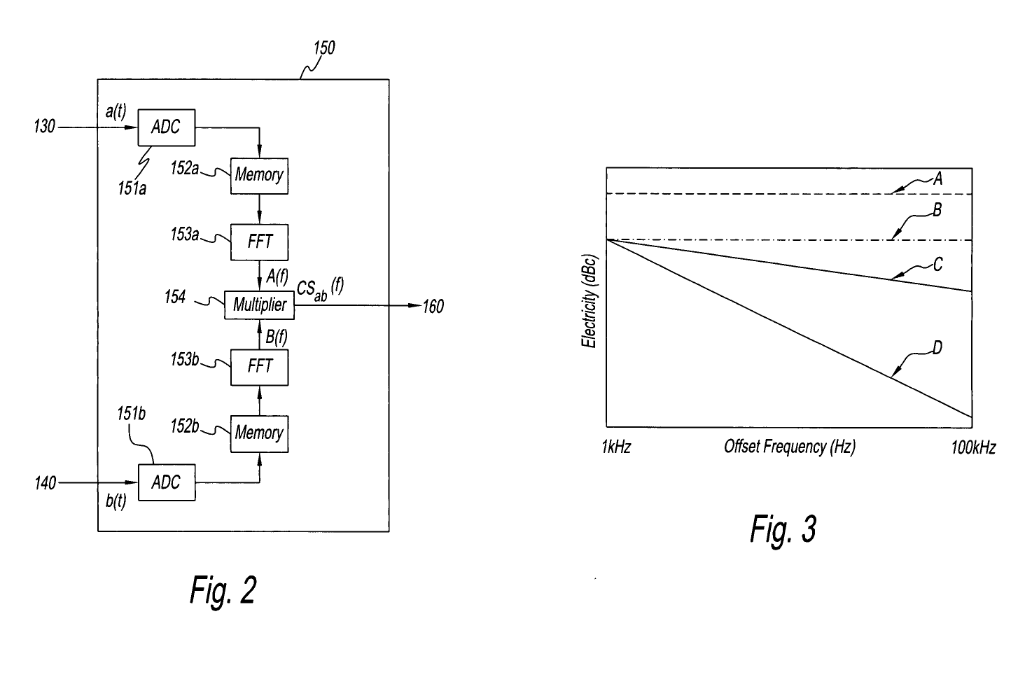

Phase noise measurement apparatus 100 is constructed as described below. That is, phase noise measurement apparatus 100 consists of an input terminal 110, a distributor 120, a PLL block 130, which is an example of a phase detection means, a PLL block 140, which is an example of a phase detection means, a correlating device 150; an averaging device 160, and an output device 170. Input terminal 110 is a terminal for receiving signals V under test. Distributor 120 is a device that distributes and outputs signals V under test that have been received at input terminal 110 to PLL block 130 and PLL block 140. PLL block 130 is a device that detects the phase of signals Vₐ distributed from distributor 120. PLL block 130 comprises a mixer 131, a filter 132, and a signal source 133. Distributed signals Vₐ and the output signals of signal source 133 are input to mixer 131 and the mixer outputs the phase difference between these signals. Filter 132 is a loop filter that restricts the bandwidth of the PLL. Signal source 133 is a signal source that restricts the frequency and phase of the output signals in accordance with the output signals of filter 132. PLL block 140 is a device that detects the phase of signals V_{b} distributed from distributor 120. PLL block 140 comprises a mixer 141, a filter 142, and a signal source 143. Distributed signals V_{b} and the output signals from signal source 143 are input to mixer 141 and the mixer outputs the phase difference between these signals. Filter 142 is a loop filter that restricts the PLL bandwidth. Signal source 143 is a signal source that restricts the frequency and phase of the output signals in accordance with the output signals of filter 142. Correlating device 150 is a device that finds the cross spectrum between phase signals a(t), which are the output signals of PLL block 130, and phase signals b(t), which are the output signals of PLL block 140. Correlating device 150 will be described in detail while referring to FIG. 2.

FIG. 2 is a block diagram showing the structure of correlating device 150. Correlating device 150 in FIG. 2 comprises an analog-digital converter 151a, a memory 152a, a fast Fourier transform device 153a, which is an example of a spectrum analyzing means, an analog-digital converter 151b, a memory 152b, a fast Fourier transform device 153b, which is an example of a spectrum analyzing means, and a multiplier 154. Hereafter, the analog-digital converter is referred to as an ADC and the fast Fourier transform device is referred to as an FFT. There are also cases where FFT is used as an abbreviation for fast Fourier transform. ADC 151a is a device that performs analog-digital conversion of phase signals a(t). Memory 152a is a device that stores the digitized phase signals a(t), which are the results of ADC 151a conversion. FFT 153a performs Fourier transform of phase signals a(t) stored in memory 152a. Moreover, a component A(f) with a Nyquist frequency of (fs/2) or less is output to multiplier 154 from the results of Fourier transform of phase signals a(t). ADC 151b is the device that performs analog-digital conversion of phase signals b(t). It should be noted that ADC 151a and ADC 151b have the same conversion processing speed fs (samples/second). Memory 152b is the device that stores digitized phase signals b(t), which are the result of ADC 151b conversion. FFT 153b performs Fourier transform of phase signals b(t) stored in memory 152b. Moreover, a component B(f) with a Nyquist frequency of fs/2 or less is output to multiplier 154 from the results of Fourier transform of phase signals b(t). FFT 153a and FFT 153b have the same number of points. Multiplier 154 performs the processing represented by the following formula on the Fourier transform result A(f) and the Fourier transform result B(f).

[Mathematical Formula 1]
S_{ab}(f)=A(f)B(f)* (1)

S_{ab}(f) is the cross spectrum between a(t) and b(t). The asterisk indicates complex conjugation.

S_{ab}(f), which is the processing result of multiplier 154, is output to averaging device 160.

Refer to FIG. 1 again. Averaging device 160 performs the averaging represented by the following formula on the processing results S_{ab}(f).

$$\\ {AS}_{ab} ( f ) = \frac{1}{N} {\sum }_{k = 1}^{N} {S}_{ab} ( k , f ) \qquad ( 2 )$$

N is an integer of 1 or higher. S_{ab}(k,f) is a cross spectrum S_{ab}(f) obtained after k number of times. As previously described, averaging a plurality of complex numbers as real number portions and imaginary portions separately is “vector averaging” in the present Specification. In contrast to this, averaging the size (absolute number) or the power (square of the absolute number) of a plurality of complex numbers is “scalar averaging.” The “average” function in general measuring apparatuses uses scalar averaging.

Output device 170 is a liquid crystal display or other device that displays the processing result AS_{ab}(f) of averaging device 160 (not illustrated), a printer or other printing device that displays the results (not illustrated), or a device that outputs the results to a LAN interface or other communications device (not illustrated).

The theory behind phase noise measurement using correlating or cross spectrum processing is described below. First, the phase of signals V under test is φ(t), the phase of the output signals of signal source 133 is φₐ(t), and the phase of the output signals of signal source 143 is φ_{b}(t). Phase signals a(t) and b(t) at this time are represented by the following formulas.

[Mathematical Formula 3]
a(t)∝[φ(t)−φₐ(t)] (3)

[Mathematical Formula 4]
b(t)∝[φ(t)−φ_{b}(t)] (4)

Moreover, correlation C_{ab}(τ) between phase signals a(t) and b(t) is represented by the following formula.

[Mathematical Formula 5]

$$\\ {C}_{ab} ( τ ) = {lim}_{T -> ∞} \frac{1}{T} {\int }_{0}^{T} a ( t ) b ( t - τ ) ⅆ t \qquad ( 5 )$$

Cross spectrum S_{ab}(f) of phase signals a(t) and b(t) is obtained by Fourier transform of correlation C_{ab}(τ) represented by formula (5). The one-sided spectrum of cross spectrum S_{ab}(f) is represented by the following formulas.

[Mathematical Formula 6]

$$\\ {S}_{ab} ( f ) = 2 {\int }_{- ∞}^{∞} {C}_{ab} ( τ ) {ⅇ}^{- j2π f τ} ⅆ τ ( f > 0 ) \qquad ( 6 )$$

[Mathematical Formula 7]
s_{ab}(f)=0 (f<0) (7)

The following formulas are obtained assuming that the phase φ(t) of the signals V under test, the phase φₐ(t) of the output signals of signal source 133, and the phase φ_{b}(t) of the output signals of signal source 143 are independent of one another.

[Mathematical Formula 8]
C_{ab}(τ)∝[C_{φφ}(τ)+C_{φ}_{ₐ}_{φ}_{_{b}}(τ)−C_{φφ}_{_{b}}(τ)−C_{φφ}_{_{b}}(τ)] (8)

[Mathematical Formula 9]
S_{ab}(f)∝[S_{φ}(f)+S_{φ}_{ₐ}_{φ}_{_{b}}(f)−S_{φφ}_{_{b}}(f)−S_{φφ}_{_{b}}(f)] (9)

C_{100 φ}(t) is the auto-correlation of φ(t). C_{φaφb}(t) is the correlation between φₐ(t) and φ_{b}(t). C_{φφa}(t) is the correlation between φ(t) and φₐ(t). C_{φφb}(t) is the correlation between φ(t) and φ_{b}(t).

In addition, S_{φ}(f) is the spectrum of φ(t). S_{φaφb}(f) is the cross spectrum between φₐ(t) and φ_{b}(t). S_{φφa}(f) is the cross spectrum between φ(t) and φₐ(t). S_{φφb}(f) is the cross spectrum between φ(t) and φ_{b}(t).

The correlation components in formulas (8) and (9) approach zero as the above-mentioned integration time T increases and formulas (8) and (9) can be represented as follows.

[Mathematical Formula 10]
C_{ab}(τ)∝C_{φφ}(τ) (10)

[Mathematical Formula 11]
S_{ab}(f)∝S_{φ}(f) (11)

There are often cases when real time correlation processing integrated over a long time becomes difficult, or a large number of resources become necessary. By means of the present invention, long-term integrated correlating and equivalent processing are performed by finding two or more cross spectra between phase signals a(t) and phase signals b(t) in a limited time and vector averaging the resulting two or more cross spectra in order to simplify the device structure. In other words, correlated phase noise is obtained by converting the cross spectra that are eventually obtained to a time range.

Moreover, the above-mentioned theory is established when the loop bandwidth of the PLL, or the phase detection means, is regarded as zero. The loop bandwidth of PLL block 130 or PLL block 140 is not actually zero. Consequently, the phase signals extracted by the PLL are a certain component confined to within the loop band of the PLL. For instance, when the open loop gain of PLL block 130 and PLL loop 140 is 10 dB, the component of phase signal a(t) and phase signal b(t) within the loop band of PLL block 130 and PLL block 140 is 10 dB lower than the original value. In order to solve this problem, apparatus 100 for measuring phase noise, and the phase noise measuring apparatus of another embodiment discussed later in the patent, are such that they compensate for a component within the loop band of the PLL of the spectrum that is eventually obtained.

Apparatus 100 for measuring phase noise structured as described above operates as follows. First, PLL block 130 is phase locked with respect to the distributed signals Vₐ. Moreover, PLL block 140 is phase locked with respect to distributed signals V_{b}. Thus, phase signals a(t), which are the phase noise component of signals V under test, are output from PLL block 130. Moreover, phase signals b(t), which are the phase noise component of signals V under test, are output from PLL block 140. Correlating device 150 finds a specific number only of cross spectra between phase signals a(t) and phase signals b(t). Averaging device 160 vector averages one or more cross spectra obtained from correlating device 150. Phase noise component φₐ(t) generated by signal source 133 and phase noise component φ_{b}(t) generated by signal source 143 can approach zero as the number of cross spectra that are the subject of averaging increases at this time. As described above, the averaging of a plurality of spectra each obtained at different times is called averaging in terms of time in the present Specification. On the other hand, averaging of a plurality of components with different corresponding frequencies in the same spectrum is called averaging in terms of frequency in the present Specification.

Thus, the above-mentioned cross spectrum corresponds to linearly spaced frequencies. However, at least the frequency axis is generally represented on a log scale when the results of phase noise measurement are output. Therefore, averaging device 160 maps the cross spectrum corresponding to linearly spaced frequencies to logarithmically spaced frequencies using vector averaging in terms of frequency. An example of this procedure is described below.

First, the ADC conversion rate is 250 k samples/second. Moreover, the number of FFT points is 128. The FFT points at this time are as shown in Table 1. Only the points of Nyquist frequency or lower are represented with the corresponding frequency in Table 1.

TABLE 1
FFT points

| Count | Frequency |
|---|---|
| 0 | 0 |
| 1 | 1,953 |
| 2 | 3,906 |
| 3 | 5,859 |
| 4 | 7,813 |
| 5 | 9,766 |
| 6 | 11,719 |
| 7 | 13,672 |
| 8 | 15,625 |
| 9 | 17,578 |
| 10 | 19,531 |
| 11 | 21,484 |
| 12 | 23,438 |
| 13 | 25,391 |
| 14 | 27,344 |
| 15 | 29,297 |
| 16 | 31,250 |
| 17 | 33,203 |
| 18 | 35,156 |
| 19 | 37,109 |
| 20 | 39,063 |
| 21 | 41,016 |
| 22 | 42,969 |
| 23 | 44,922 |
| 24 | 46,875 |
| 25 | 48,828 |
| 26 | 50,781 |
| 27 | 52,734 |
| 28 | 54,688 |
| 29 | 56,641 |
| 30 | 58,594 |
| 31 | 60,547 |
| 32 | 62,500 |
| 33 | 64,453 |
| 34 | 66,406 |
| 35 | 68,359 |
| 36 | 70,313 |
| 37 | 72,266 |
| 38 | 74,219 |
| 39 | 76,172 |
| 40 | 78,125 |
| 41 | 80,078 |
| 42 | 82,031 |
| 43 | 83,984 |
| 44 | 85,938 |
| 45 | 87,891 |
| 46 | 89,844 |
| 47 | 91,797 |
| 48 | 93,750 |
| 49 | 95,703 |
| 50 | 97,656 |
| 51 | 99,609 |
| 52 | 101,563 |
| 53 | 103,516 |
| 54 | 105,469 |
| 55 | 107,422 |
| 56 | 109,375 |
| 57 | 111,328 |
| 58 | 113,281 |
| 59 | 115,234 |
| 60 | 117,188 |
| 61 | 119,141 |
| 62 | 121,094 |
| 63 | 123,047 |
| 64 | 125,000 |
| | (Hz) |

Next, the cross spectrum corresponding to the linearly spaced frequencies shown in Table 1 are mapped to the logarithmically spaced frequencies shown in Table 2. The cross spectrum is represented by the 21 logarithmically spaced frequency points between 1 kHz and 100 kHz.

TABLE 2

| | |
|---|---|
| Displayed point | FFT count |

| | | Boundary | Start | End |
|---|---|---|---|---|
| Count | Frequency | frequency | point | point |
| | | 891 | | |
| 0 | 1,000 | | 1 | 1 |
| | | 1,122 | | |
| 1 | 1,259 | | 1 | 1 |
| | | 1,413 | | |
| 2 | 1,585 | | 1 | 1 |
| | | 1,778 | | |
| 3 | 1,995 | | 1 | 1 |
| | | 2,239 | | |
| 4 | 2,512 | | 2 | 2 |
| | | 2,818 | | |
| 5 | 3,162 | | 2 | 2 |
| | | 3,548 | | |
| 6 | 3,981 | | 2 | 2 |
| | | 4,467 | | |
| 7 | 5,012 | | 2 | 2 |
| | | 5,623 | | |
| 8 | 6,310 | | 3 | 3 |
| | | 7,079 | | |
| 9 | 7,943 | | 4 | 4 |
| | | 8,913 | | |
| 10 | 10,000 | | 5 | 5 |
| | | 11,220 | | |
| 11 | 12,589 | | 6 | 7 |
| | | 14,125 | | |
| 12 | 15,849 | | 8 | 9 |
| | | 17,783 | | |
| 13 | 19,953 | | 10 | 11 |
| | | 22,387 | | |
| 14 | 25,119 | | 12 | 14 |
| | | 28,184 | | |
| 15 | 31,623 | | 15 | 18 |
| | | 35,481 | | |
| 16 | 39,811 | | 19 | 22 |
| | | 44,668 | | |
| 17 | 50,119 | | 23 | 28 |
| | | 56,234 | | |
| 18 | 63,096 | | 29 | 36 |
| | | 70,795 | | |
| 19 | 79,433 | | 37 | 45 |
| | | 89,125 | | |
| 20 | 100,000 | | 46 | 57 |
| | (Hz) | 112,202 | | |
| | | (Hz) | | |

The frequencies that correspond to the display points are shown in Table 2. The frequencies corresponding to the middle points between adjacent display points are shown as boundary frequencies. By means of this procedure, a linearly spaced frequency point that is between these boundary frequencies is selected while referring to the boundary frequencies on either side of each display point. Vector averaging is performed on the cross spectra corresponding to the selected frequency points. The results of vector averaging eventually become the cross spectrum of logarithmically spaced display points.

For instance, the cross spectrum of display points of count 14 is obtained as described below. First, the boundary frequencies on either side of the display point of count 14 are referenced. These frequencies are 22,387 Hz and 28,184 Hz. Next, the FFT points included between these two frequencies are found from Table 1. FFT points from count 12 to count 14 are found. Next, vector averaging of the cross spectra at the three FFT points that were found is performed. The one cross spectrum obtained by averaging is the cross spectrum of the display point of count 14. In another case, the boundary frequencies on either side of the display point of count 4 are 2,239 Hz and 2,818 Hz. However, the FFT points that are included between these two frequencies cannot be found from Table 1. In such a case, the boundary frequency on the high-frequency side is increased one at a time. Thus, the FFT point of count 2 [in Table 1] is found when the boundary frequency on the high-frequency side is 4,467 Hz. When there is one FFT point, the original value and the averaged value will be the same. Consequently, the cross spectrum at the FFT point of count 2 becomes the untouched cross spectrum of the display point of count 4. The start point and end point of the FFT point described above are shown in Table 2.

In addition, when the number of points of FFT is 1024, the start point and the end point of the related FFT points is as shown in Table 3.

TABLE 3

| | |
|---|---|
| Displayed point | FFT count |

| | | Boundary | Start | End |
|---|---|---|---|---|
| Count | Frequency | frequency | point | point |
| | | 891 | | |
| 0 | 1,000 | | 4 | 4 |
| | | 1,122 | | |
| 1 | 1,259 | | 5 | 5 |
| | | 1,413 | | |
| 2 | 1,585 | | 6 | 7 |
| | | 1,778 | | |
| 3 | 1,995 | | 8 | 9 |
| | | 2,239 | | |
| 4 | 2,512 | | 10 | 11 |
| | | 2,818 | | |
| 5 | 3,162 | | 12 | 14 |
| | | 3,548 | | |
| 6 | 3,981 | | 15 | 18 |
| | | 4,467 | | |
| 7 | 5,012 | | 19 | 23 |
| | | 5,623 | | |
| 8 | 6,310 | | 24 | 28 |
| | | 7,079 | | |
| 9 | 7,943 | | 29 | 36 |
| | | 8,913 | | |
| 10 | 10,000 | | 37 | 45 |
| | | 11,220 | | |
| 11 | 12,589 | | 46 | 57 |
| | | 14,125 | | |
| 12 | 15,849 | | 58 | 72 |
| | | 17,783 | | |
| 13 | 19,953 | | 73 | 91 |
| | | 22,387 | | |
| 14 | 25,119 | | 92 | 115 |
| | | 28,184 | | |
| 15 | 31,623 | | 116 | 145 |
| | | 35,481 | | |
| 16 | 39,811 | | 146 | 182 |
| | | 44,668 | | |
| 17 | 50,119 | | 183 | 230 |
| | | 56,234 | | |
| 18 | 63,096 | | 231 | 289 |
| | | 70,795 | | |
| 19 | 79,433 | | 290 | 365 |
| | | 89,125 | | |
| 20 | 100,000 | | 366 | 459 |
| | (Hz) | 112,202 | | |
| | | (Hz) | | |

When two or more FFT points have been found, vector averaging is performed in terms of frequency. The phase noise component φₐ(t) generated by signal source 133 and the phase noise component φ_{b}(t) generated by signal source 143 come even closer to zero with an increase in the number of averaging objects.

Therefore, a graph representing the results of averaging is shown in FIG. 3. FIG. 3 is the cross spectrum displayed on a log-log graph when ideal signals V under test completely free of phase noise are input to apparatus 100. The y-axis of the graph in FIG. 3 is electricity and the x-axis is offset frequency. The curves in FIG. 3 are the so-called noise floor. Curve A is the cross spectrum when only one cross spectrum is found and the above-mentioned vector averaging in terms of frequency is not performed. It should be noted that the real curve A is a curve that drops off gently with an increase in frequency. However, in the present Specification it is assumed that curve A is a horizontal curve in order to simplify the description. Moreover, curves B and C represent the difference from curve A. Curve B is the cross spectrum when the cross spectrum is found a plurality of times and vector averaging in terms of time is performed on the resulting plurality of cross spectra. It should be noted that the above-mentioned vector averaging in terms of frequency is not performed on curve B. Curves C and D are the cross spectrum when the cross spectrum is found a plurality of times, and vector averaging in terms of time, as well as vector averaging in terms of frequency, are performed on the resulting plurality of cross spectra. Curve C is related to Table 2. Curve D is related to Table 3. As is clear from FIG. 3, the internal noise decreases with an increase in the number of averaging objects.

The vector averaging in terms of frequency described above can be performed before or after the averaging in terms of time is performed by averaging device 160.

By means of the method that was illustrated above, a spectrum that falls within a pre-determined frequency range from among logarithmically spaced frequencies is selected from a spectrum corresponding to linearly spaced frequencies and vector averaging is performed on the selected spectrum. The method whereby vector averaging in terms of frequency is performed on a spectrum that corresponds to linearly spaced frequencies while the number of averaging objects increases logarithmically with an increase in frequency is another method for mapping a cross spectrum corresponding to linearly spaced frequencies to logarithmically spaced frequencies. There are cases where it is difficult to arrange frequencies points with perfectly regular spacing because of insufficient calculation precision, and the like. In this case, the frequency points can also be arranged with approximately regular spacing.

The processing results of averaging device 160 are eventually output to output device 170. For instance, the averaged cross spectrum is displayed as a graph on a liquid crystal display (not illustrated) as the result of phase noise measurement. The denotation dBc/Hz is generally used as the unit for phase noise measurement; therefore, what is often used is the cross spectrum that is obtained by dividing the resulting spectrum by the equivalent noise band and normalizing the product for 1 Hz. Furthermore, the result of correcting the frequency properties of the receiving system as needed are also output.

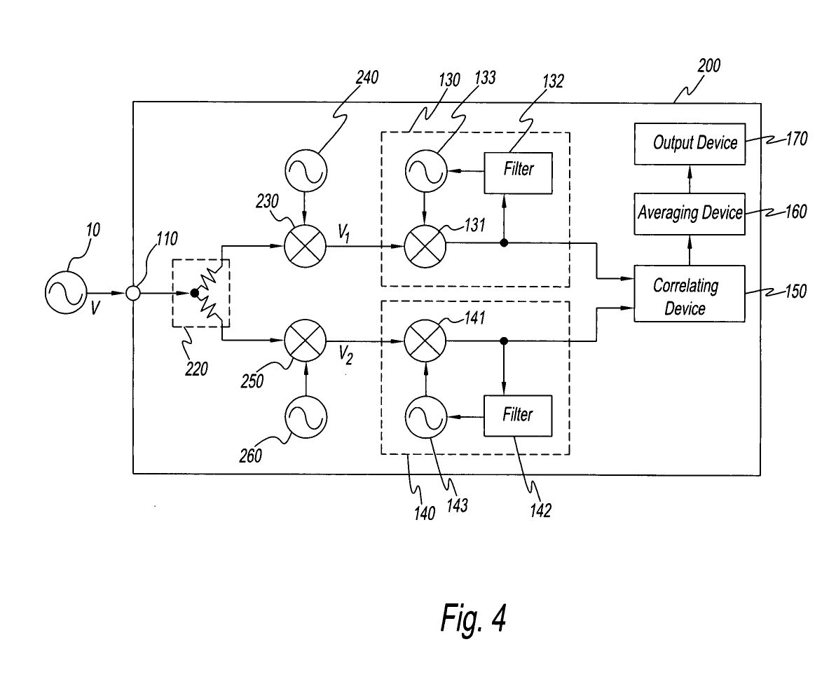

Next, an apparatus 200 for measuring phase noise, which is capable of measuring the phase noise of signals V under test having a broader frequency range will be described as the second embodiment of the present invention. A block diagram showing the structure of the second embodiment of the present invention, apparatus 200 for measuring phase noise, is shown in FIG. 4. The same reference symbols are used for the same structural elements as in FIG. 1 and a description thereof is omitted.

Apparatus 200 for measuring phase noise in FIG. 4 comprises, in addition to apparatus 100 for measuring phase noise, a mixer 230, a signal source 240, a mixer 250, and a signal source 260. Moreover, apparatus 200 for measuring phase noise comprises a distributor 220 in place of distributor 120. Distributor 220 is a distributor with a broader bandwidth than distributor 120. The frequency of the output signals of signal sources 240 and 260 is variable. The set of mixer 230 and signal source 240 and the set of mixer 250 and signal source 260 make up respective frequency conversion devices. When the frequency of the output signals of signal source 240 and the frequency of the output signals of signal source 260 are different, an intermediate signal V₁, which is the output signal of mixer 230, and an intermediate signal V₂, which is the output signal of mixer 250, will have different frequencies. In this case, signal source 133 and signal source 143 are set at different frequencies. The frequency of the output signals of signal source 240 and signal source 260 can be fixed. However, in this case the measurement frequency range is restricted.

When frequency conversion is performed in accordance with conventional methods, signals V under test are frequency converted before they reach distributor 220. However, by means of the present invention, frequency conversion is performed with separate devices downstream of distributor 220. Thus, as long as there is a separate signal processor in each circuit between the distributor and the phase detection means when signals under test are processed before they reach the phase detection means, the effect of a phase noise component generated by these signal processor on the phase noise measurement results for the signals under test can be reduced. That is, the phase noise component that is produced by mixer 230, signal source 240, mixer 250, and signal source 260 is processed as a correlation component at correlating device 150 that is downstream of these components; therefore, the effect on the results of measuring the phase noise of signals V under test can be reduced.

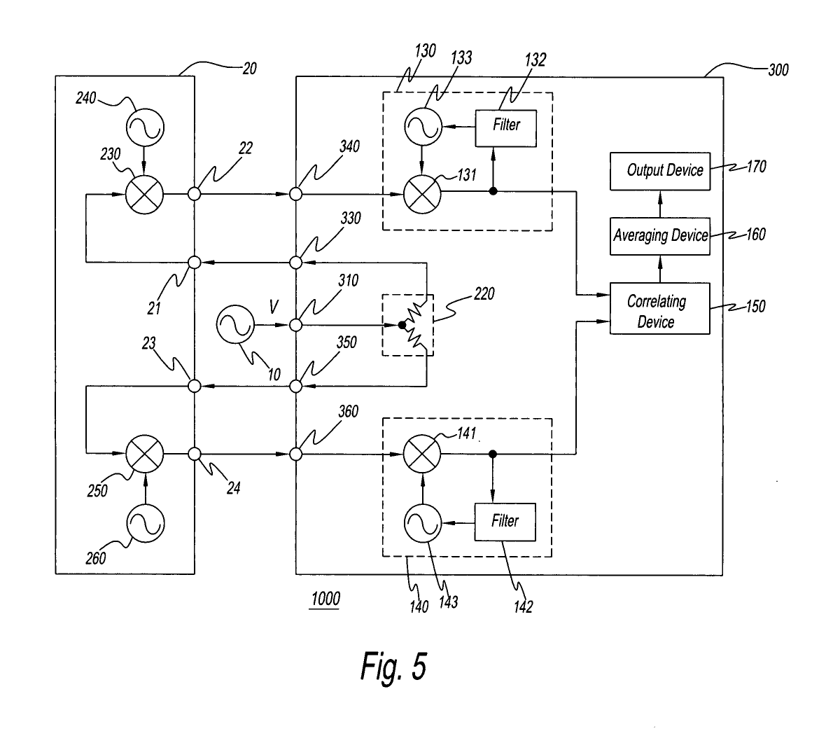

Next, the phase noise measuring system capable of measuring the phase noise of signals V under test from a broader frequency range will be described as a third embodiment of the present invention. A block diagram showing the structure of the third embodiment of the present invention, a phase noise measuring system 1000, is shown in FIG. 5. The same reference symbols are used for the same structural elements as in FIG. 4 and a description thereof is omitted. Refer to FIG. 5 hereafter. Phase noise measuring system 1000 comprises an apparatus 300 for measuring the phase noise and a frequency conversion box 20.

Apparatus 300 for measuring the phase noise is apparatus 200 for measuring phase noise from which mixer 230, signal source 240, mixer 250, and signal source 260 have been removed and to which input terminals 310, 340, and 360 and output terminals 330 and 350 have been added. Input terminal 310 is the terminal for receiving signals V under test and feeding the received signals to distributor 220. Output terminals 330 and 350 are connected to distributor 220. Distributor 220 distributes the signals V under test received at input terminal 310, outputting these signals to output terminals 330 and 350, respectively. Input terminal 340 is the terminal for receiving intermediate signals V₁ and feeds the received signals to PLL block 130. Input terminal 360 is the terminal for receiving intermediate signals V₂ and feeds the received signals to PLL block 140. Intermediate signals V₁ are signals distributed from signals V under test by distributor 220, or signals that have been further frequency converted by mixer 230 and signal source 240 after distribution. In addition, intermediate signals V₂ are signals distributed from signals V under test by distributor 220 or signals that have been further frequency converted by mixer 250 and signal source 260 after distribution.

Frequency conversion box 20 has input terminals 21 and 23, output terminals 22 and 24, signal sources 240 and 260, and mixers 230 and 250. Input terminal 21 is connected to output terminal 330. Moreover, input terminal 23 is connected to output terminal 350. Output terminal 22 is connected to input terminal 340. Output terminal 24 is further connected to input terminal 360. The signals received by input terminal 21 of frequency conversion box 20 are frequency converted by mixer 230 to which signal source 240 is connected and output by output terminal 22. The signals received by input terminal 23 are frequency converted by mixer 250 to which signal source 260 has been connected and output by output terminal 24. It should be noted that frequency conversion box 20 has a connector terminal (not illustrated) for receiving control information from apparatus 300 for measuring phase noise or a PC or other outside control device. Moreover, the frequency of the output signals of signal source 240 and signal source 260 are controlled by apparatus 300 for measuring phase noise.

As previously described, the test operator opens the connection circuit between distributor 220 and PLL block 130 via the pair of output terminal 330 and input terminal 340. Moreover, the test operator opens the connection circuit between distributor 220 and PLL block 140 via the pair of output terminal 350 and input terminal 360. When frequency conversion is not necessary, the circuit between output terminal 330 and input terminal 340, and the circuit between output terminal 350 and input terminal 360 should be shorted. When frequency conversion is necessary, output terminal 330 should be connected to input terminal 21, output terminal 22 should be connected to input terminal 340, output terminal 350 should be connected to input terminal 23, and output terminal 24 should be connected to input terminal 360. As with apparatus 200 for measuring phase noise, phase noise measuring system 1000 has separate signal processor in the circuits between the distributors and the phase detection means; therefore, it is possible to reduce the effect of the phase noise component produced by these signal processor on the results of phase noise measurement of the signals under test. Moreover, phase noise measuring system 1000 can selectively perform frequency conversion. Apparatus 300 for measuring phase noise receives signals V under test; therefore it can easily house a device that measures other parameters of signals V under test.

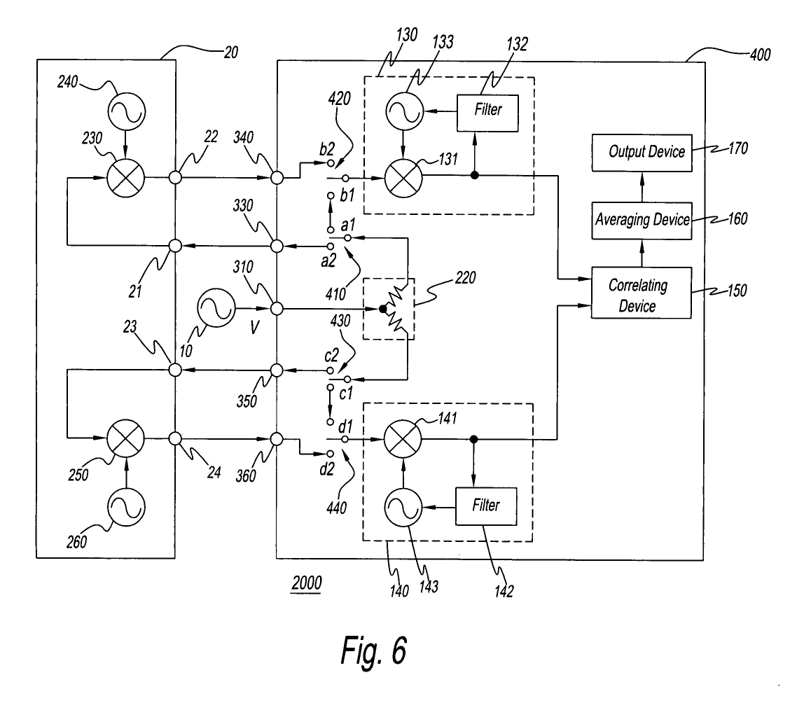

Next, another phase noise measuring system capable of measuring the phase noise of signals V under test of a broader frequency range is described below as a fourth embodiment of the present invention. A block diagram showing the structure of the fourth embodiment of the present invention, a phase noise measuring system 2000, is shown in FIG. 6. The same reference symbols are used for the same structural elements as in FIG. 5 and a description thereof is omitted. Refer to FIG. 6 hereafter. Phase noise measuring system 2000 has frequency conversion box 20 and an apparatus 400 for measuring phase noise.

Apparatus 400 for measuring phase noise in FIG. 6 is apparatus 200 for measuring phase noise to which switches 410, 420, 430, and 440 have further been added. Distributor 220 is connected to switches 410 and 430 in place of output terminals 330 and 350. Output terminal 330 is connected to switch 410. Output terminal 350 is connected to switch 430. PLL block 130 is connected to switch 420 in place of input terminal 340. PLL block 140 is connected to switch 440 in place of input terminal 360. Input terminal 340 is connected to switch 420. Input terminal 360 is connected to switch 440. Switch 410 feeds one of the output signals of distributor 220 to output terminal 330 and switch 420. Switch 420 feeds signals from input terminal 340 or signals from switch 410 to PLL block 130. Switch 430 feeds another output signal from distributor 220 to output terminal 350 or switch 440. Switch 440 feeds signals from input terminal 360 or signals from switch 430 to PLL block 140.

When signals V under test are of a relatively low frequency, switch 410 selects the a1 side, switch 420 selects the b1 side, switch 430 selects the c1 side, and switch 440 selects the d1 side. Each of the output signals of distributor 220 are fed to PLL block 130 or PLL block 140 without being processed. On the other hand, when signals V under test are of relatively high frequency, switch 410 selects the a2 side, switch 420 selects the b2 side, switch 430 selects the c2 side, and switch 440 selects the d2 side. Each of the output signals of distributor 220 are fed to PLL block 130 and PLL block 140 after separate frequency conversion. Phase noise measuring system 2000 is constructed as described above; therefore, there are fewer problems with the terminal connection that is associated with the selection of the measurement frequency range when compared to phase noise measuring system 1000.

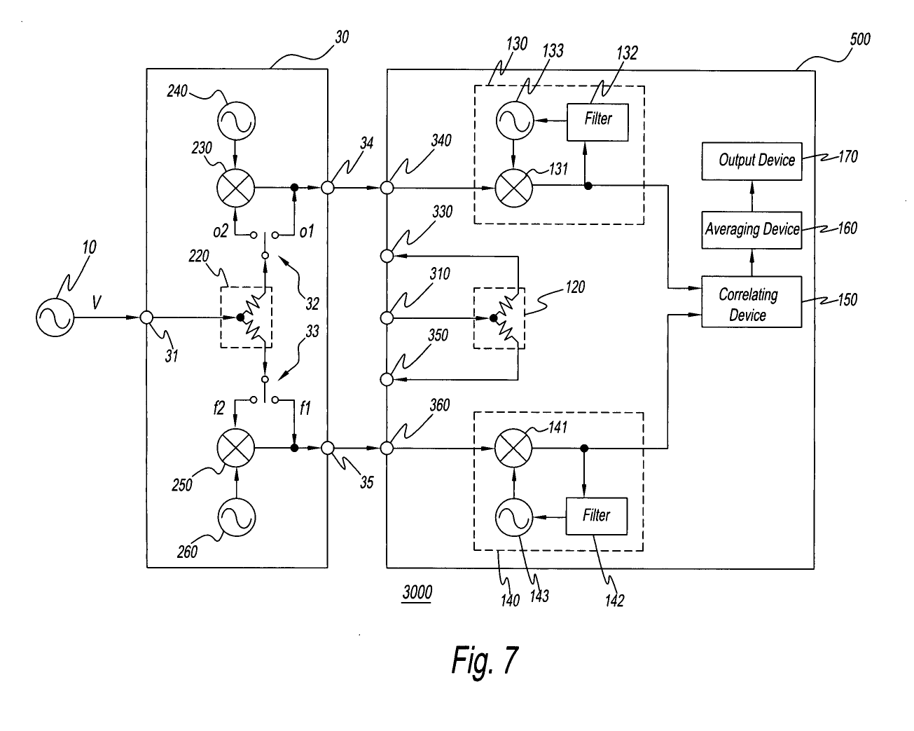

Next, another phase noise measuring system capable of measuring the phase noise of signals under test of a broader frequency range will be described as the fifth embodiment of the present invention. A block diagram showing the structure of the fifth embodiment of the present invention, a phase noise measuring system 3000, is shown in FIG. 7. The same reference symbols are used for the same structural elements as in FIG. 5 and a description thereof is omitted. Refer to FIG. 7 hereafter. Phase noise measuring system 3000 comprises a frequency conversion box 30 and an apparatus 500 for measuring phase noise.

Apparatus 500 for measuring phase noise comprises distributor 120 in place of distributor 220 of apparatus 300 for measuring phase noise. Distributor 120 is the same as the distributor shown in FIG. 1 and has a narrow bandwidth when compared to distributor 220.

Frequency conversion box 30 comprises an input terminal 31, distributor 220, signal sources 240 and 260, mixers 230 and 250, switches 32 and 33, and output terminals 34 and 35. Input terminal 31 is the terminal for receiving signals V under test. Distributor 220 is the device that distributes signals V under test that have been received at input terminal 31, outputting these signals to switches 32 and 33. Switch 32 feeds the distributed signals to mixer 230 or output terminal 34. Switch 33 feeds the distributed signals to mixer 250 or output terminal 35. Mixer 230 is connected to signal source 240. Moreover, mixer 230 converts the frequency of the output signals of switch 32 and outputs these signals to output terminal 34. Mixer 250 is connected to signal source 260. Moreover, mixer 250 frequency converts the output signals of switch 33 and outputs these signals to output terminal 35. Output terminal 34 is connected to input terminal 340. Moreover, output terminal 35 is connected to input terminal 360.

When signals V under test are of relatively low frequency, switch 32 selects the e1 side and switch 33 selects the f1 side. Direct-current signals are further output from signal sources 240 and 260. The output signals from distributor 220, unprocessed at this time, are fed to phase noise measuring device 500. When signals V under test are of relatively high frequency, switch 32 selects the e2 side and switch 33 selects the f2 side. The output signals from distributor 220 are frequency converted and then fed to phase noise measuring device 500. Frequency conversion box 30 has a connector terminal (not illustrated) for receiving control information from phase noise measuring apparatus 500 or a PC or other outside control device. The frequency of the output signals of signal source 240 and signal source 260 is controlled by apparatus 500 for measuring phase noise. The selection status of switches 32 and 33 is controlled by apparatus 500 for measuring phase noise. Phase noise measuring system 3000 is structured as described above; therefore, it is possible to reduce the problems associated with terminal connection when the measured frequency range is selected.

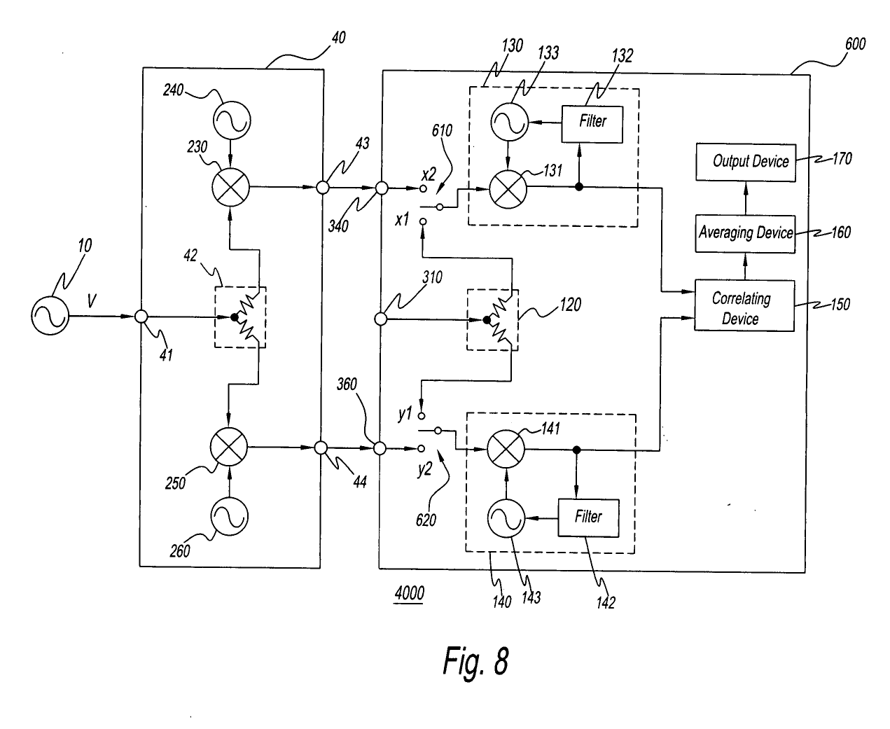

Next, another phase noise measuring system capable of measuring the phase noise of signals under test of a broader frequency range will be described as the sixth embodiment of the present invention. A block diagram showing the structure of the sixth embodiment of the present invention, a phase noise measuring system 4000, is shown in FIG. 8. The same reference symbols are used in FIG. 8 for the same structural elements as in FIG. 7 and a description thereof is omitted. Refer to FIG. 8 hereafter. Phase noise measuring system 4000 comprises a frequency conversion box 40 and an apparatus 600 for measuring phase noise.

Apparatus 600 for measuring phase noise is apparatus 500 for measuring phase noise from which output terminals 330 and 350 have been removed and to which switches 610 and 620 have been added. Distributor 120 is connected to switches 610 and 620. Distributor 120 distributes signals V under test received at input terminal 310 and feeds each of the distributed signals to switches 610 and 620. PLL block 130 is connected to switch 610 in place of input terminal 340. Moreover, input terminal 340 is connected to switch 610. PLL block 140 is connected to switch 620 in place of input terminal 360. Input terminal 360 is connected to switch 620.

Frequency conversion box 40 comprises an input terminal 41, a distributor 42, signal sources 240 and 260, and mixers 230 and 250. Input terminal 41 is the terminal for receiving signals V under test. Distributor 42 is the device that distributes signals V under test that have been received at input terminal 41 and feeds these signals to mixers 230 and 250. Mixer 230 is connected to signal source 240. Mixer 230 converts the frequency of one of the signals distributed by distributor 42 and outputs this to output terminal 43. Mixer 250 is connected to signal source 260. Moreover, mixer 250 converts the frequency of another signal distributed by distributor 42 and outputs this to output terminal 44. Output terminal 43 is connected to input terminal 340. Output terminal 44 is connected to input terminal 360.

When the signals under test are of relatively low frequency, device under test 10 is connected to input terminal 310. Moreover, switch 610 of apparatus 600 for measuring phase noise selects the x1 side and switch 620 selects the y1 side. One of the output signals of distributor 120 is fed through switch 610 to PLL block 130 at this time. Moreover, another of the output signals of distributor 120 is fed through switch 620 to PLL block 140. On the other hand, when the signals V under test are of relatively high frequency, device under test 10 is connected to input terminal 41. Switch 610 of apparatus 600 for measuring phase noise selects the x2 side and switch 620 selects the y2 side. The signals output from output terminal 43 are fed through switch 610 to PLL block 130 at this time. Moreover, the signals output from output terminal 44 are fed through switch 620 to PLL block 140. It should be noted that frequency conversion box 40 has a connector terminal (not illustrated) for receiving control information from apparatus 600 for measuring phase noise or a PC or other outside control apparatus. The frequency of the output signals of signal source 240 and signal source 260 is controlled by apparatus 600 for measuring phase noise. Apparatus 600 for measuring phase noise is structured as described above; therefore, it is not necessary to detach frequency conversion box 40 when the measured frequency range changes.

Signal sources 133 and 143 can precisely set the frequency of the output signals in accordance with the frequency of signals V under test in the embodiments described thus far. In general, this type of a signal source produces the desired frequency f_{LO} in addition to a spurious frequency of f_{SUPR} as represented by the following formula.

[Mathematical Formula 12]
f_{SUPR}=|i·f_{LO}±j·f_{ref}| (12)

Notations i and j here are integers of one or greater. Notation f_{Lo} is the frequency of the output signals of the signal source. Moreover, f_{ref} is the reference signal frequency of this signal source.

This spurious frequency can have an effect on the results of measuring the phase noise of signals V under test. For instance, when frequency f_{SUPR} is approximately the same as frequency f_{LO}, this spurious effect is measured as phase noise of signal V under test. Therefore, an apparatus for measuring phase noise that eliminates this type of spurious effect is described below as an alternate embodiment of the present invention.

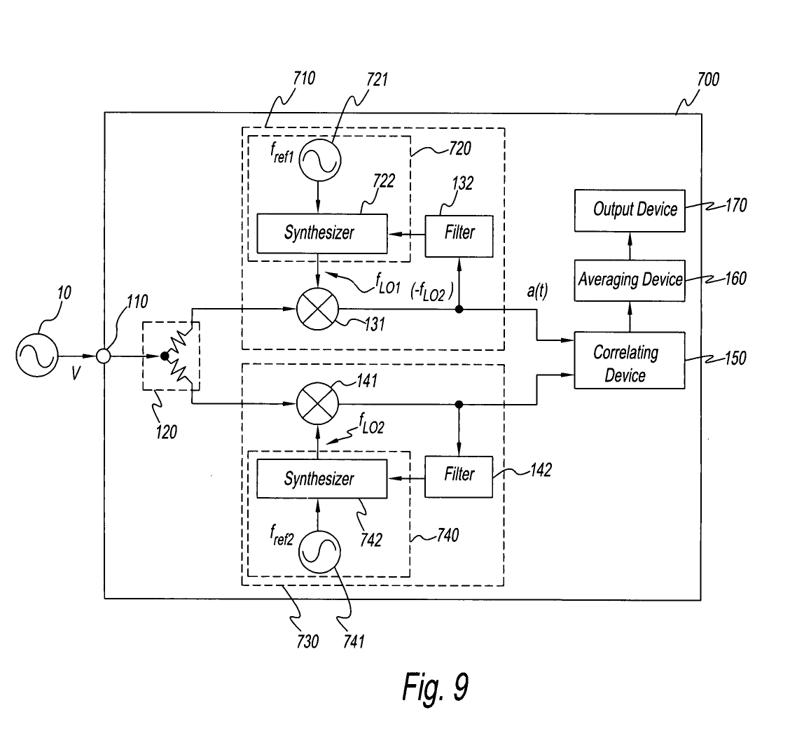

A block diagram showing the structure of the seventh embodiment of the present invention, an apparatus 700 for measuring phase noise, is shown in FIG. 9. The same reference symbols are used in FIG. 9 for the same structural elements as in FIG. 1 and a description thereof is omitted. Apparatus 700 for measuring phase noise in FIG. 9 is apparatus 100 for measuring phase noise wherein a PLL block 710 is substituted for PLL block 130 and a PLL block 730 is substituted for PLL block 140. PLL block 710 is PLL block 130 in which a signal source 720 is substituted for signal source 133. PLL block 730 is PLL block 140 in which a signal source 740 has been substituted for signal source 143.

Signal source 720 has a reference signal source 721 and a synthesizer 722. Synthesizer 722 generates and outputs local signals while referring to the output signals of reference signal source 721. The frequency and phase of the output signals of synthesizer 722 are controlled by the output signals of filter 132. Moreover, signal source 740 has a reference signal source 741 and a synthesizer 742. Synthesizer 742 generates and outputs local signals while referring to the output signals of reference signal source 741. The frequency and phase of the output signals of synthesizer 742 are controlled by the output signals of filter 142. The frequency F_{LO1} of the output signals of synthesizer 722 and the frequency f_{LO2} of the output signals of synthesizer 742 are the same. On the other hand, frequency F_{ref1} of the output signals of reference signal source 721 and frequency f_{ref2} of the output signals of reference signal source 741 are different. When the spurious frequency output from synthesizer 722 at this time is f_{SUPR1} and the spurious frequency output from synthesizer 742 is f_{SUPR2}, ·f_{SUPR1}≠f_{SUPR2}. These spurious frequencies are treated as independent components by correlating device 150 that comes later; therefore, these are brought to zero by averaging the cross spectrum. The spurious frequency-reducing effect inclusively increases as frequency f_{ref1} and frequency f_{ref2} grow farther apart. Moreover, frequency f_{ref1} and frequency f_{ref2} should be separated by at least the predetermined frequency f_{diff}. It should be noted that frequency f_{diff} is the reciprocal of the time when one cross spectrum processing is the object (observation time). For instance, when 1024-point FFT processing is performed on the results of analog-digital conversion at 32 kHz by correlating apparatus 150, one observation time is 32 milliseconds. Consequently, frequency f_{diff} in this case becomes 31.25 Hz. Of course, even if frequency f_{ref1} and frequency f_{ref2} are not separated by at least the pre-determined frequency f_{diff}, this does not mean that there will be no spurious frequency-reducing effect at all. The extent to which frequency f_{ref1} and frequency f_{ref2} are separated from one another depends on the percentage to which the spurious effect must be reduced. The above-mentioned technology for reducing the spurious effect can also be used with the apparatuses for measuring phase noise in the other embodiments. For instance, the frequency of the reference signal source for signal source 133 and signal source 143 should be different in apparatus 200 for measuring phase noise. In this case, it is not necessary for the frequency of the output signals of signal source 133 and the frequency of the output signals of signal source 143 to be the same. Moreover, it is preferred that the frequency is different for the reference signal source of signal sources 240, 260, 133, and 143 in apparatus 200 for measuring phase noise.

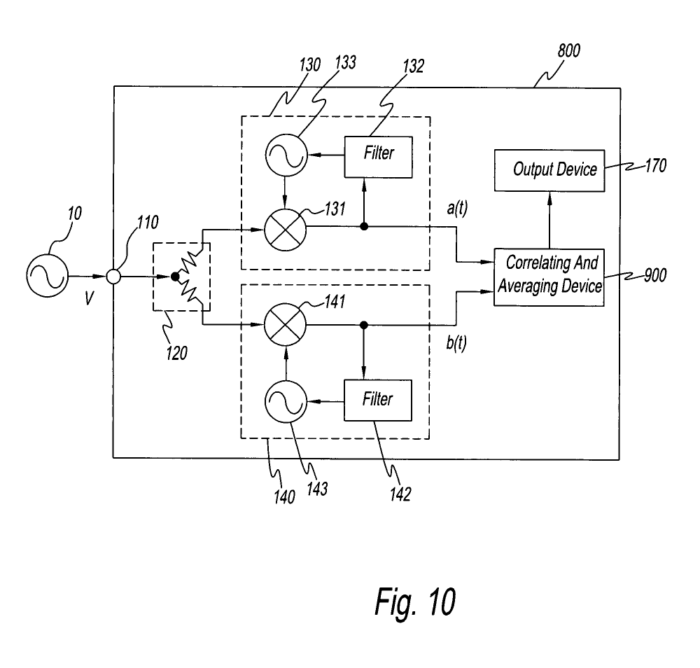

Nevertheless, when the entire bandwidth of a spectrum is operated at high frequency resolution, a large number of measurement resources are needed. A phase noise measuring apparatus that solves this type of problem is described below as an eighth embodiment of the present invention. Refer to FIG. 10 here. FIG. 10 is a drawing showing the eighth embodiment of the present invention, an apparatus 800 for measuring phase noise. The same reference symbols are used in FIG. 10 for the same structural elements as in FIG. 1 and a description thereof is omitted.

Apparatus 800 for measuring phase noise in FIG. 10 comprises input terminal 110, distributor 120, PLL block 130, PLL block 140, a correlation averaging device 900, and output device 170. Correlation averaging device 900 finds the cross spectrum between phase signals a(t), which are the output signals of PLL block 130, and phase signals b(t), which are the output signals of PLL block 140. Correlation averaging device 900 further averages the resulting cross spectra.

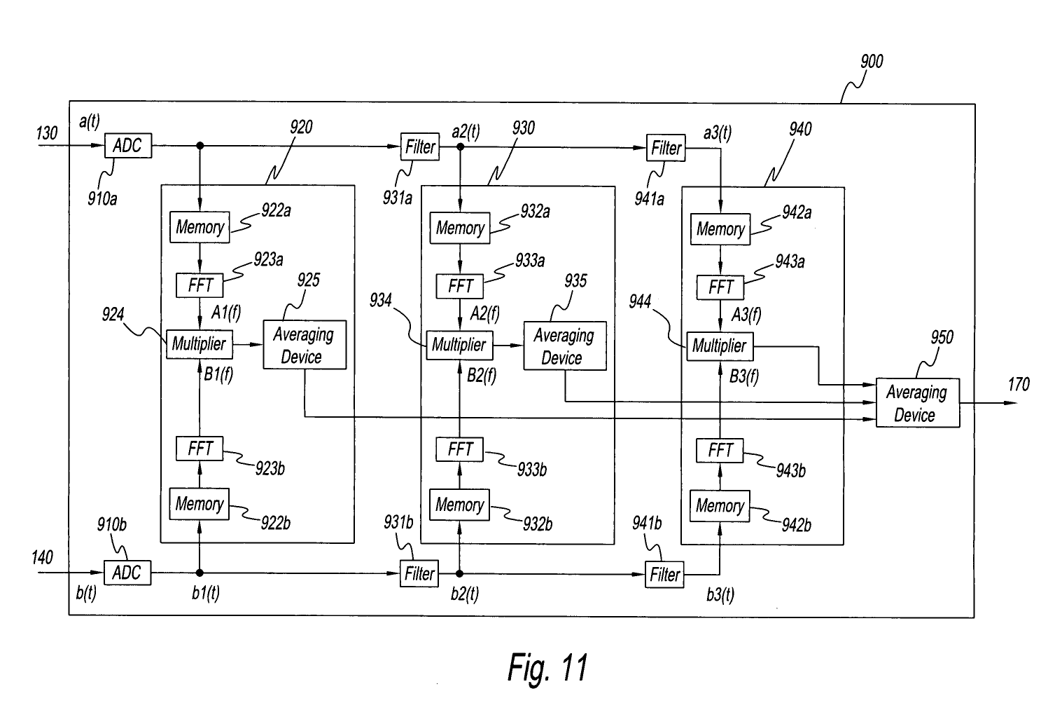

Correlation averaging device 900 will be described in detail while referring to FIG. 11 here. FIG. 11 is a drawing showing the structure of correlation averaging device 900. In FIG. 11, correlation averaging device 900 comprises an ADC 910a, an ADC 910b, a correlating block 920, a correlating block 930, a filter 931a, a filter 931b, a correlating block 940, a filter 941a, a filter 941b, and an averaging device 950. ADC 910a is the device that performs analog-digital conversion of phase signals a(t). ADC 910b is the device that performs analog-digital conversion of phase signals b(t). ADC 910a and ADC 910b have the same conversion rate fs (samples/second). Phase signal a1(t), which is the result of conversion by ADC 910a, and phase signal b1(t), which is the result of conversion by ADC 910b, are input to correlating block 920. Filters 931a, 931b, 941a, and 941b are ⅛^{th} decimation filters. Filter 931a brings the bandwidth and rate of phase signal a1(t) to ⅛. Filter 931b brings the bandwidth and rate of phase signal b1(t) to ⅛. Filter 941a brings the bandwidth and rate of phase signal a2(t), which is the output of filter 931a, to ⅛. Filter 941b brings the bandwidth and rate of phase signal b2(t), which is the output of filter 931b, to ⅛.

Correlating block 920 is the device that generates the cross spectrum between phase signals a1(t) and phase signals b1(t). Correlating block 920 has a memory 922a, a memory 922b, an FFT 923a, an FFT 923b, a multiplier 924, and an averaging device 925. Memory 922a is the device that stores phase signals a1(t). FFT 923a Fourier transforms phase signals a1(t) stored in memory 922a. Moreover, component A1(f) with a Nyquist frequency of (fs/2) or lower is output from among the results of Fourier transform of phase signals a1(t) to multiplier 924. Memory 922b is the device that stores phase signals b1(t). FFT 923b performs Fourier transform of phase signals b1(t) stored in memory 922b. Moreover, component B1(f) with a Nyquist frequency of (fs/2) or less is output to multiplier 924 from the results of Fourier transform of phase signals b1(t). FFT 923a and FFT 923b have the same frequency. Multiplier 924 processes Fourier transform result A1(f) and Fourier transform result b1(f) as shown by the following formula.

[Mathematical Formula 13]
S1_{ab}(f)=A1(f)B1(f) (13)

S1_{ab}(f) is the cross spectrum of a1(t) and b1(t). Moreover, the asterisk indicates complex conjugation.

S1_{ab}(f), which is the result of the processing performed by multiplier 924, is output to averaging unit 925. Averaging unit 925 performs vector averaging in terms of time on processing result S1_{ab}(f) in accordance with the following formula.

$$\\ {AS1}_{ab} ( f ) = \frac{1}{64} {\sum }_{k = 1}^{64} {S1}_{ab} ( k , f ) \qquad ( 14 )$$

S1_{ab}(k,f) is cross spectrum S1_{ab}(f) obtained after k times.

The averaged cross spectrum AS1_{ab}(f), which is the result of processing by averaging unit 925, is output to averaging unit 950.

Correlating block 930 is the device that produces a cross spectrum between phase signals a2(t) and phase signals b2(t). Correlating block 930 comprises a memory 932a, a memory 932b, an FFT 933a, an FFT 933b, a multiplier 934, and an averaging unit 935. Memory 932a is the device that stores phase signal a2(t). FFT 933a performs Fourier transform of phase signals a2(t) stored in memory 932a. Moreover, component A with a Nyquist frequency of (fs/16) or lower is output to multiplier 934 from the results of Fourier transform of phase signal a2(t). Memory 932b is the device that stores phase signals b2(t). FFT 933b performs Fourier transform of phase signal b2(t) stored in memory 932b. Moreover, component b2(f) with a Nyquist frequency of (fs/16) or less is output to multiplier 934 from the results of Fourier transform of phase signal b2(t). It should be noted that FFT 923a and FFT 933b have the same number of points. Multiplier 934 processes the Fourier transform result A2(f) and the Fourier transform result B2(f) in accordance with the following formula.

[Mathematical Formula 15]
S2_{ab}(f)=A2(f)B2(f)* (15)

S2_{ab}(f) is the cross spectrum between a2(t) and b2(t). Moreover, the asterisk indicates complex conjugation.

S2_{ab}(f), which is the result of processing by multiplier 934, is output to averaging unit 935. Averaging unit 935 performs vector averaging in terms of time on processing result S2^{ab}(f) in accordance with the following formula.

[Mathematical Formula 16]

$$\\ {AS2}_{ab} ( f ) = \frac{1}{8} {\sum }_{k = 1}^{A} {S2}_{ab} ( k , f ) \qquad ( 16 )$$

S2_{ab}(k,f) is the cross spectrum S2_{ab}(f) obtained after k times.

The averaged cross spectrum AS2_{ab}(f), which is the result of processing by averaging unit 935, is output to averaging unit 950.

Correlating block 940 is the device that generates the cross spectrum between phase signals a3(t), which represents the output of filter 941a, and phase signals b3(t), which represents the output of filter 941b. Correlating block 940 comprises a memory 942a, a memory 942b, an FFT 943a, an FFT 943b, and a multiplier 944. Memory 942a is the device that stores phase signals a3(t). FFT 943a performs Fourier transform of phase signals a3(t) stored in memory 942a. Moreover, component A3(f) with a Nyquist frequency of (fs/128) or less is output to multiplier 944 from the results of Fourier transform of phase signal a3(t). Memory 942b is the device that stores phase signals b3(t). FFT 943b outputs component B3(f) with a Nyquist frequency (fs/128) or less to multiplier 944 from the results of Fourier transform of phase signals b3(t). FFT 923a and FFT 923b have the same number of points. Multiplier 944 processes Fourier transform result A3(f) and Fourier transform result B3(f) in accordance with the following formula.

[Mathematical Formula 17]
S3_{ab}(f)=A3(f)B3(f)* (17)

S3_{ab}(f) is the cross spectrum between a3(t) and b3(t). Moreover, the asterisk indicates complex conjugation.

S3_{ab}(f), which is the result of processing by multiplier 944, is output to averaging unit 950.

It should be kept in mind that when one S3_{ab}(f) value is obtained, eight S2_{ab}(f) values are obtained and 64 s1_{ab}(f) values are obtained. The eight S2_{ab}(f) values are averaged to become one AS2_{ab}(f) value. Moreover, the 64 S1_{ab}(f) values are averaged to become one AS1_{ab}(f) value.

Processing results AS1_{ab}(f), AS2_{ab}(f), and S3_{ab}(f) value of each correlating block correspond to linearly spaced frequencies. However, at least the frequency axis is displayed with a log scale in the measurement results of phase noise. Consequently, processing results AS1_{ab}(f), AS2_{ab}(f), and S3_{ab}(f) must be mapped to logarithmically spaced frequencies. Therefore, one cross spectrum mapped to logarithmically spaced frequencies is produced by combining the processing results As1_{ab}(f), As2_{ab}(f), and S3_{ab}(f) of each correlating block. An example of this procedure is described below.

First, the ADC 910a and ADC 910b conversion rates are 100 M samples/second. The number of FFT points in each correlating block is 128 points. The number of FFT points in correlating block 920 at this time is as shown in Table 4. Moreover, the FFT points in correlating block 930 are as shown in Table 5. The FFT points in correlating block 940 are as shown in Table 6. Only the points with a Nyquist frequency or less are shown together with the corresponding frequency in these tables.

TABLE 4
FFT points

| Count | Frequency |
|---|---|
| 0 | 0 |
| 1 | 781,250 |
| 2 | 1,562,500 |
| 3 | 2,343,750 |
| 4 | 3,125,000 |
| 5 | 3,906,250 |
| 6 | 4,687,500 |
| 7 | 5,468,750 |
| 8 | 6,250,000 |
| 9 | 7,031,250 |
| 10 | 7,812,500 |
| 11 | 8,593,750 |
| 12 | 9,375,000 |
| 13 | 10,156,250 |
| 14 | 10,937,500 |
| 15 | 11,718,750 |
| 16 | 12,500,000 |
| 17 | 13,281,250 |
| 18 | 14,062,500 |
| 19 | 14,843,750 |
| 20 | 15,625,000 |
| 21 | 16,406,250 |
| 22 | 17,187,500 |
| 23 | 17,968,750 |
| 24 | 18,750,000 |
| 25 | 19,531,250 |
| 26 | 20,312,500 |
| 27 | 21,093,750 |
| 28 | 21,875,000 |
| 29 | 22,656,250 |
| 30 | 23,437,500 |
| 31 | 24,218,750 |
| 32 | 25,000,000 |
| 33 | 25,781,250 |
| 34 | 26,562,500 |
| 35 | 27,343,750 |
| 36 | 28,125,000 |
| 37 | 28,906,250 |
| 38 | 29,687,500 |
| 39 | 30,468,750 |
| 40 | 31,250,000 |
| 41 | 32,031,250 |
| 42 | 32,812,500 |
| 43 | 33,593,750 |
| 44 | 34,375,000 |
| 45 | 35,156,250 |
| 46 | 35,937,500 |
| 47 | 36,718,750 |
| 48 | 37,500,000 |
| 49 | 38,281,250 |
| 50 | 39,062,500 |
| 51 | 39,843,750 |
| 52 | 40,625,000 |
| 53 | 41,406,250 |
| 54 | 42,187,500 |
| 55 | 42,968,750 |
| 56 | 43,750,000 |
| 57 | 44,531,250 |
| 58 | 45,312,500 |
| 59 | 46,093,750 |
| 60 | 46,875,000 |
| 61 | 47,656,250 |
| 62 | 48,437,500 |
| 63 | 49,218,750 |
| 64 | 50,000,000 |
| | (Hz) |

TABLE 5
FFT points

| Count | Frequency |
|---|---|
| 0 | 0 |
| 1 | 97,656 |
| 2 | 195,313 |
| 3 | 292,969 |
| 4 | 390,625 |
| 5 | 488,281 |
| 6 | 585,938 |
| 7 | 683,594 |
| 8 | 781,250 |
| 9 | 878,906 |
| 10 | 976,563 |
| 11 | 1,074,219 |
| 12 | 1,171,875 |
| 13 | 1,269,531 |
| 14 | 1,367,188 |
| 15 | 1,464,844 |
| 16 | 1,562,500 |
| 17 | 1,660,156 |
| 18 | 1,757,813 |
| 19 | 1,855,469 |
| 20 | 1,953,125 |
| 21 | 2,050,781 |
| 22 | 2,148,438 |
| 23 | 2,246,094 |
| 24 | 2,343,750 |
| 25 | 2,441,406 |
| 26 | 2,539,063 |
| 27 | 2,636,719 |
| 28 | 2,734,375 |
| 29 | 2,832,031 |
| 30 | 2,929,688 |
| 31 | 3,027,344 |
| 32 | 3,125,000 |
| 33 | 3,222,656 |
| 34 | 3,320,313 |
| 35 | 3,417,969 |
| 36 | 3,515,625 |
| 37 | 3,613,281 |
| 38 | 3,710,938 |
| 39 | 3,808,594 |
| 40 | 3,906,250 |
| 41 | 4,003,906 |
| 42 | 4,101,563 |
| 43 | 4,199,219 |
| 44 | 4,296,875 |
| 45 | 4,394,531 |
| 46 | 4,492,188 |
| 47 | 4,589,844 |
| 48 | 4,687,500 |
| 49 | 4,785,156 |
| 50 | 4,882,813 |
| 51 | 4,980,469 |
| 52 | 5,078,125 |
| 53 | 5,175,781 |
| 54 | 5,273,438 |
| 55 | 5,371,094 |
| 56 | 5,468,750 |
| 57 | 5,566,406 |
| 58 | 5,664,063 |
| 59 | 5,761,719 |
| 60 | 5,859,375 |
| 61 | 5,957,031 |
| 62 | 6,054,688 |
| 63 | 6,152,344 |
| 64 | 6,250,000 |
| | (Hz) |

TABLE 6
FFT points

| Count | Frequency |
|---|---|
| 0 | 0 |
| 1 | 12,207 |
| 2 | 24,414 |
| 3 | 36,621 |
| 4 | 48,828 |
| 5 | 61,035 |
| 6 | 73,242 |
| 7 | 85,449 |
| 8 | 97,656 |
| 9 | 109,863 |
| 10 | 122,070 |
| 11 | 134,277 |
| 12 | 146,484 |
| 13 | 158,691 |
| 14 | 170,898 |
| 15 | 183,105 |
| 16 | 195,313 |
| 17 | 207,520 |
| 18 | 219,727 |
| 19 | 231,934 |
| 20 | 244,141 |
| 21 | 256,348 |
| 22 | 268,555 |
| 23 | 280,762 |
| 24 | 292,969 |
| 25 | 305,176 |
| 26 | 317,383 |
| 27 | 329,590 |
| 28 | 341,797 |
| 29 | 354,004 |
| 30 | 366,211 |
| 31 | 378,418 |
| 32 | 390,625 |
| 33 | 402,832 |
| 34 | 415,039 |
| 35 | 427,246 |
| 36 | 439,453 |
| 37 | 451,660 |
| 38 | 463,867 |
| 39 | 476,074 |
| 40 | 488,281 |
| 41 | 500,488 |
| 42 | 512,695 |
| 43 | 524,902 |
| 44 | 537,109 |
| 45 | 549,319 |
| 46 | 561,523 |
| 47 | 573,730 |
| 48 | 585,938 |
| 49 | 598,145 |
| 50 | 610,352 |
| 51 | 622,559 |
| 52 | 634,766 |
| 53 | 646,973 |
| 54 | 659,180 |
| 55 | 671,387 |
| 56 | 683,594 |
| 57 | 695,801 |
| 58 | 708,008 |
| 59 | 720,215 |
| 60 | 732,422 |
| 61 | 744,629 |
| 62 | 756,836 |
| 63 | 769,043 |
| 64 | 781,250 |
| | (Hz) |

The cross spectrum corresponding to linearly regularly spaced frequencies shown in Tables 4, 5 and 6 is mapped to logarithmically spaced frequencies as shown in Table 7. The cross spectrum is represented by 51 logarithmically spaced frequency points between 100 kHz and 45 MHz.

TABLE 7

| Display points | | | FFT count | | |
|---|---|---|---|---|---|
| | | Boundary | | Start | End |
| Count | Frequency | frequency | Block | point | point |
| | | 94,074 | | | |
| 0 | 100,000 | | 940 | 8 | 8 |
| | | 106,300 | | | |
| 1 | 112,996 | | 940 | 9 | 9 |
| | | 120,115 | | | |
| 2 | 127,682 | | 940 | 10 | 11 |
| | | 135,725 | | | |
| 3 | 144,276 | | 940 | 12 | 12 |
| | | 153,365 | | | |
| 4 | 163,026 | | 940 | 13 | 14 |
| | | 173,296 | | | |
| 5 | 184,213 | | 940 | 15 | 16 |
| | | 195,818 | | | |
| 6 | 208,154 | | 940 | 17 | 18 |
| | | 221,267 | | | |
| 7 | 235,207 | | 940 | 19 | 20 |
| | | 250,024 | | | |
| 8 | 265,775 | | 940 | 21 | 23 |
| | | 282,518 | | | |
| 9 | 300,316 | | 940 | 24 | 26 |
| | | 319,235 | | | |
| 10 | 339,346 | | 940 | 27 | 29 |
| | | 360,724 | | | |
| 11 | 383,448 | | 940 | 30 | 33 |
| | | 407,604 | | | |
| 12 | 433,282 | | 940 | 34 | 37 |
| | | 460,578 | | | |
| 13 | 489,593 | | 940 | 38 | 42 |
| | | 520,436 | | | |
| 14 | 553,222 | | 940 | 43 | 47 |
| | | 588,074 | | | |
| 15 | 625,121 | | 940 | 49 | 54 |
| | | 664,501 | | | |
| 16 | 706,363 | | 940 | 55 | 61 |
| | | 750,862 | | | |
| 17 | 798,164 | | 930 | 8 | 8 |
| | | 848,446 | | | |
| 18 | 901,896 | | 930 | 9 | 9 |
| | | 958,713 | | | |
| 19 | 1,019,109 | | 930 | 10 | 11 |
| | | 1,083,310 | | | |
| 20 | 1,151,556 | | 930 | 12 | 12 |
| | | 1,224,101 | | | |
| 21 | 1,301,216 | | 930 | 13 | 14 |
| | | 1,383,189 | | | |
| 22 | 1,470,326 | | 930 | 15 | 16 |
| | | 1,562,952 | | | |
| 23 | 1,661,414 | | 930 | 17 | 18 |
| | | 1,776,078 | | | |
| 24 | 1,877,336 | | 930 | 19 | 20 |
| | | 1,995,603 | | | |
| 25 | 2,121,320 | | 930 | 21 | 23 |
| | | 2,254,958 | | | |
| 26 | 2,397,014 | | 930 | 24 | 26 |
| | | 2,548,019 | | | |
| 27 | 2,708,537 | | 930 | 27 | 29 |
| | | 2,879,167 | | | |
| 28 | 3,060,547 | | 930 | 30 | 33 |
| | | 3,253,353 | | | |
| 29 | 3,458,305 | | 930 | 34 | 37 |
| | | 3,676,168 | | | |
| 30 | 3,907,757 | | 930 | 38 | 42 |
| | | 4,153,934 | | | |
| 31 | 4,415,621 | | 930 | 43 | 48 |
| | | 4,693,792 | | | |
| 32 | 4,989,488 | | 930 | 49 | 54 |
| | | 5,303,812 | | | |
| 33 | 5,637,938 | | 930 | 55 | 61 |
| | | 5,993,112 | | | |
| 34 | 6,370,661 | | 920 | 8 | 8 |
| | | 6,771,995 | | | |
| 35 | 7,198,612 | | 920 | 9 | 9 |
| | | 7,652,104 | | | |
| 36 | 8,134,166 | | 920 | 10 | 11 |
| | | 8,646,595 | | | |
| 37 | 9,191,307 | | 920 | 12 | 12 |
| | | 9,770,333 | | | |
| 38 | 10,385,837 | | 920 | 13 | 14 |
| | | 11,040,116 | | | |
| 39 | 11,735,612 | | 920 | 15 | 15 |
| | | 12,474,923 | | | |
| 40 | 13,260,809 | | 920 | 16 | 18 |
| | | 14,096,203 | | | |
| 41 | 14,984,224 | | 920 | 19 | 20 |
| | | 15,928,188 | | | |
| 42 | 16,931,620 | | 920 | 21 | 23 |
| | | 17,998,265 | | | |
| 43 | 19,132,105 | | 920 | 24 | 26 |
| | | 20,337,375 | | | |
| 44 | 21,618,572 | | 920 | 27 | 29 |
| | | 22,980,482 | | | |
| 45 | 24,428,188 | | 920 | 30 | 33 |
| | | 25,967,096 | | | |
| 46 | 27,602,951 | | 920 | 34 | 37 |
| | | 29,341,860 | | | |
| 47 | 31,190,315 | | 920 | 38 | 42 |
| | | 33,155,218 | | | |
| 48 | 35,243,904 | | 920 | 43 | 47 |
| | | 37,464,172 | | | |
| 49 | 39,824,310 | | 920 | 48 | 54 |
| | | 42,333,131 | | | |
| 50 | 45,000,000 | | 920 | 55 | 61 |
| | (Hz) | 47,834,875 | | | |
| | | (Hz) | | | |

The display points and corresponding frequencies are shown in Table 7. The frequency corresponding to a middle point between adjacent display points is shown as the boundary frequency. By means of this procedure, linearly spaced frequency points between these boundary frequencies are selected. The cross spectrum corresponding to the selected frequency point is vector averaged. The averaging results eventually serve as the cross spectrum of logarithmically spaced display points.

For instance, the cross spectrum of the display point of count 8 is obtained as follows. First, the boundary frequency on either side of the display point of count 8 is referenced. That is, the boundary frequencies of 250,024 Hz and 282,518 Hz are referenced. Next, the FFT points included within these two frequencies are found from Tables 4, 5, and 6. In order to discover as many FFT points as possible, the points are found in order beginning with table showing the smallest frequency spacing. That is, the FFT points are found in accordance with the order of Tables 6, Table 5, and Table 4. Thus, FFT points from count 21 to count 23 are found in Table 6 relating to correlating block 940. Next, the vector average of the cross spectrum at the three resulting FFT points is found. The one cross spectrum obtained by averaging is the cross spectrum of the display point at count 8. Moreover, the cross spectrum of the display point of count 17 is obtained as follows. The boundary frequencies on either side of the display point of count 17 are 750,862 Hz and 848,446 Hz. The display points of counts 62 to count 64 are found in Table 6. Frequency components exceeding the Nyquist frequency not shown in Tables 6 (793,457 Hz, 805,664 Hz, 817,871 Hz, 830,078 Hz, 842,285 Hz) are included between the 750,862 Hz and 848,446 Hz. Vector averaging of this component is the main cause of errors in the measurement results; therefore, it is unacceptable. Consequently, FFT points are similarly found from Table 5 relating to correlating block 930. When this is done, FFT points of count 8 are found in Table 5. When there is one FFT point, the original value is the same as the averaged value. Consequently, the cross spectrum at the FFT point of count 8 becomes the cross spectrum of the display point of count 17. The start point and the end point of the related FFT point and the correlating block related to these points are shown in Table 7.

When two or more FFT points are found, vector averaging in terms of frequency is performed on the cross spectrum. The phase noise component generated by signal source 133 and the phase noise component generated by signal source 143 approach zero as the number of averaging objects increases.

By means of the method illustrated above, the spectrum included within a predetermined frequency range of logarithmically spaced frequencies is selected from a spectrum corresponding to linearly spaced frequencies and the selected spectrum is vector averaged. The method whereby a spectrum corresponding to linearly spaced frequencies is vector averaged in terms of frequency as the number of averaging objects increases logarithmically with an increase in frequency is another method of mapping a cross spectrum corresponding to linearly spaced frequencies to correspond to logarithmically spaced frequencies. There are cases where it is actually difficult to arrange each frequency point with perfectly regularly spacing due to insufficient calculation precision, and the like. In this case, each frequency point should be arranged with approximately regularly spacing.

The one cross spectrum obtained from processing results AS1_{ab}(f), AS2_{ab}(f), and S3_{ab}(f) becomes SW_{ab}(f) as a result of the vector averaging in terms of frequency described above. Correlation averaging device 900 finds a predetermined number of cross spectra SW_{ab}(f) only. Moreover, averaging unit 950 vector averages cross spectrum SW_{ab}(f) in terms of time as represented by the following formula.

[Mathematical Formula 18]

$$\\ {ASW}_{ab} ( f ) = \frac{1}{N} {\sum }_{k = 1}^{N} {SW}_{ab} ( k , f ) \qquad ( 18 )$$

N is an integer of 1 or higher. SW_{ab}(k,f) is the cross spectrum SW_{ab}(f) obtained after k times. The phase noise component generated by signal source 133 and the phase noise component generated by signal source 143 can move closer to zero with an increase in the number N of cross spectra, which are the subjects of averaging.

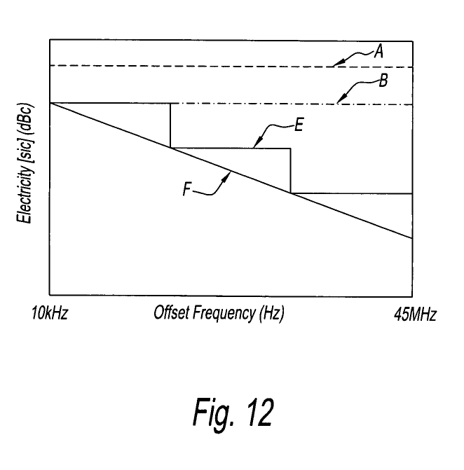

Next, a graph showing the results of averaging is shown in FIG. 12. FIG. 12 shows the cross spectrum when ideal signals V under test free of any phase noise whatsoever are input to apparatus 800 for measuring phase noise represented by a logarithmic graph. The y-axis in the graph in FIG. 12 is electricity [sic] and the x-axis is the offset frequency. The curve shown in FIG. 12 is so-called noise flow. Curves A and B in FIG. 12 are shown in FIG. 3. The real curve A is not a horizontal curve and actually drops off gradually with an increase in frequency. However, in order to simplify the description, it is assumed in the present Specification that curve A is a horizontal curve. Curves E and F are the difference to curve A. Curve E is the cross spectrum when a plurality of cross spectra that had not been vector averaged in terms of frequency were found and the resulting plurality of cross spectra were vector averaged in terms of time by correlation averaging device 900. Curve E is in step form because of the averaging results from averaging units 925 and 935. Moreover, curve F is the cross spectrum when the cross spectrum SW_{ab}(f) that had been vector averaged in terms of frequency was found multiple times and the resulting plurality of cross spectra were vector averaged in terms of time. Curve F gradually drops off with an increase in frequency. In general, the phase noise decreases with an increase in offset frequency; therefore, the shape of curve F is preferred.

The averaged cross spectrum ASW_{ab} (k, f) is eventually output to output device 170.

It should be noted that the vector averaging in terms of frequency described above can be performed after vector averaging in terms of time. In this case, for instance, a new averaging unit is added after multiplier 944. Moreover, when the number of times averaging is performed by this averaging unit is m, the number of times averaging is performed by averaging unit 935 becomes (8·m), the number of times averaging is performed by averaging unit 925 becomes (64·m), and averaging unit 950 performs averaging in terms of frequency only.

By means of the eighth embodiment, the cross spectrum of two phase signals is found for a plurality of frequency ranges having different frequency bands. That is, correlating blocks 920, 930, and 940 having different frequency bands essentially are assigned a frequency band and find the cross spectrum. As a result, it is not necessary for each correlating block to have excess operating functions. For instance, the total amount of memory inside each correlating block is much smaller than the amount of memory needed when a frequency band is not assigned. Moreover, when a plurality of cross spectra are obtained within the predetermined same time, correlating blocks 920, 930, and 940 perform vector averaging in terms of time on the respective resulting plurality of cross spectra. As a result, measurement resources are conserved and precision efficiency is improved in that noise flow is reduced.

The following modifications can be applied to each of the embodiments described thus far.

The decimation percentage can be selected as needed in the eighth embodiment. Moreover, the decimation percentage of each decimation filter is not necessarily the same. For instance, when the conversion rate of ADC 910a and ADC 910b is the same, the decimation percentage of filters 931a, 931b, 941a, and 941b can be ¼. When the conversion rate of ADC 910a and ADC 910b is the same, the decimation percentage of filters 931a and 931b can be ¼ and that of filters 941a and 941b can be 1/16.

The number of correlating blocks in the eighth embodiment is not limited to three. There can be more than three or less than three correlating blocks.

The number of FFT points in each of the above-mentioned embodiments can be selected as needed. Moreover, the number of points of two FFTs connected to the multiplier is not necessarily the same as long as this does not complicate processing by this multiplier.

The ADC conversion rate can be selected as needed in each of the above-mentioned embodiments. However, it is preferred that the conversion rates of ADC 151a and ADC 151b are the same. Similarly, it is preferred that the conversion rates of ADC 910a and ADC 910b are the same.

The distributor in each of the above-mentioned embodiments is not limited to a distributor that uses a resistor as illustrated as long as it distributes signals. For instance, it can also be a distributor that uses a waveguide tube.

The structural elements of the phase noise measuring apparatus in each of the above-mentioned embodiments can actually be provided as hardware, or they can be virtually provided as software.

Moreover, the spectrum of phase signals can be found by wave rate conversion or spectrum analysis means other than FFT in each of the above-mentioned embodiments. When the spectrum obtained by the spectrum analysis means corresponds to linearly spaced frequencies, mapping to logarithmic spaced frequencies can be performed on this spectrum. When the spectrum obtained by the spectrum analysis means already corresponds to logarithmic spaced frequencies, simple addition and averaging in terms of frequency can be used as needed.

In addition, correlating device 150 in each of the above-mentioned embodiments spectrum analyzes each phase signal, finds the spectrum of each phase signal, and finds the cross spectrum thereof to obtain the spectrum of the correlation between each phase signal. Correlating device 150 can also find the correlation between two input signals first and then spectrum analyze the resulting correlation and create a cross spectrum in place of the above-mentioned processing. The same changes can be made to correlating blocks 920, 930, and 940.

The method whereby a cross spectrum corresponding to linearly spaced frequencies is mapped to logarithmically spaced frequencies by vector averaging in terms of frequency in a device can be used for phase noise measuring apparatuses as well as other measuring apparatuses that use correlating or cross spectrum processing. For instance, the above-mentioned method is effective for FFT analyzers that use correlation in order to reduce the effect of internal noise on the measurement results. That is, vector analysis in the direction of frequency is also effective for mapping to logarithmically spaced frequencies a cross spectrum of signals obtained by distribution of signals under test. The same is true for methods whereby a spectrum that falls within a predetermined frequency range of logarithmically spaced frequencies is selected from spectra corresponding to linearly spaced frequencies and the selected spectrum is vector averaged. Moreover, the same can be said for methods whereby vector averaging in the direction of frequency is performed on a spectrum corresponding to linearly spaced frequencies as the objects of averaging increase logarithmically with an increase in frequency.

1. A method for measuring phase noise, comprising
generating first phase signals representing the phase of signals under test using first local signals generated while referring to first reference signals;
generating second phase signals representing the phase of signals under test using second local signals generated while referring to second reference signals having a frequency different from that of said first reference signals; and
finding the cross correlation or cross spectrum between the first phase signals and the second phase signals.

2. The method for measuring phase noise according to claim 1, wherein said frequency difference between the first reference signals and the second reference signals is at least the frequency which is the reciprocal of the time at when this cross correlation or cross spectrum processing target.

3. An apparatus for measuring the phase noise of signals under test by a method comprising:
generating first phase signals representing the phase of signals under test using first local signals generated while referring to first reference signals;
generating second phase signals representing the phase of signals under test using second local signals generated while referring to second reference signals having a frequency different from that of said first reference signals; and
finding the cross correlation or cross spectrum between the first phase signals and the second phase signals.

4. The apparatus according to claim 3, wherein said frequency difference between the first reference signals and the second reference signals is at least the frequency which is the reciprocal of the time at when this cross correlation or cross spectrum processing target.

5. An apparatus for measuring the phase noise of signals under test by cross correlation or cross spectrum processing comprising a plurality of signal sources, wherein each of said signal sources refers to reference signals of different frequencies.

6. An apparatus for measuring the phase noise of signals under test comprising:
a first phase detector for detecting the phase of said signals under test;
a second phase detector for detecting the phase of said signals under test; and
a cross correlator for finding the cross correlation or cross spectrum between the phase signals detected by the first phase detector and the phase signals detected by the second phase detector,
wherein said first phase detector comprises a first signal source for phase detection;
wherein said second phase detector comprises a second signal source for phase detection; and
wherein said first signal source and said second signal source refer to reference signals of different frequencies.

7. The apparatus for measuring phase noise according to claim 6, further comprising:
a first signal processor with a third signal source wherein said first signal processor is located upstream of the first phase detector; and
a second signal processor with a fourth signal source wherein said second signal processor is located upstream of the second phase detection means;
wherein said first, second, third, and fourth signal sources refer to said reference signals of said different frequencies.

8. The apparatus for measuring phase noise according to claim 6, wherein the frequency difference between said reference signals is at least the frequency which is the reciprocal of the time at when this cross correlation or cross spectrum processing target.

9. The apparatus for measuring phase noise according to claim 5, wherein the frequency difference between said reference signals is at least the frequency which is the reciprocal of the time at when this cross correlation or cross spectrum processing target.
